(19) United States
(12) Patent Application Publication
(10) Pub. No.: US 2014/0122222 A1
(43) Pub. Date: May 1, 2014

(54) CUSTOMIZING ONLINE CONTENT FOR A USER

(71) Applicant: Google Inc., Mountain View, CA (US)

(72) Inventor: Aaron Nathaniel Rothman, Sunnyvale, CA (US)

(73) Assignee: Google Inc., Mountain View, CA (US)

(21) Appl. No.: 13/663,802

(22) Filed: Oct. 30, 2012

(51) Int. Cl. G06Q 30/02

(52) U.S. Cl. 705/14.44

(57) ABSTRACT

A first content includes a set of first components. A first feedback mechanism is associated with at least one first component. A second feedback mechanism is associated with the first content. A user response to the first and second feedback mechanisms is received. A second component is provided based on the user response for use in displaying at a user interface in place of at least one of the first components.

### BACKGROUND

This description relates to providing online content and, more particularly, to customizing online content for a user to more accurately serve the online content to the user.

Organizations and businesses spend billions of dollars each year on providing online content to users. To provide relevant content to users, some content providers serve online content to users based on user information. In some cases, by way of example, user information may include search terms associated with online searches, which may be used to infer possible user interests. As another example, user information may be obtained through direct user feedback including through the use of surveys and/or questionnaires.

### BRIEF DESCRIPTION OF EXAMPLE EMBODIMENTS

In one aspect, a computer-implemented method is provided for use in customizing content for a user. The method includes providing, for use in displaying at a user interface, a first content including a set of first components, a first feedback mechanism associated with at least one first component of the set of first components, and a second feedback mechanism associated with the first content, receiving a user response to the first and second feedback mechanisms, and providing, based on the user response, a second component for use in displaying at the user interface in place of at least one of the first components.

In another aspect, a computer system is provided. The computer system includes a content module and a customization module. The content module is configured to provide a first content including a set of first components. The customization module is configured to provide a first feedback mechanism associated with a first component, and a second feedback mechanism associated with the first content, receive a user response to the first and second feedback mechanisms, and provide a second component for use in displaying at a user interface in place of at least one of the first components.

In yet another aspect, one or more computer-readable storage media having computer-executable instructions embodied thereon is provided. When executed by at least one processor, the computer-executable instructions cause the processor to provide a first content including a set of first components, a first feedback mechanism associated with at least one first component of the set of first components, and a second feedback mechanism associated with the first content, and provide, based on a user response to the first and second feedback mechanisms, a second component for use in displaying at a user interface in place of at least one of the first components.

In yet another aspect, a computer system is provided. The computer system includes a processor and a computer-readable storage device having encoded thereon computer readable instructions that are executable by the processor to perform functions including providing a first content including a set of first components, a first feedback mechanism associated with at least one first component of the set of first components, and a second feedback mechanism associated with the first content, and providing, based on a user response to the first and second feedback mechanisms, a second component for use in displaying at a user interface in place of at least one of the first components.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIGS. 1-5 show example embodiments of subject matter described herein.

FIG. 1 is a schematic illustration of an example environment for customizing content based on user feedback.

FIG. 2 is a schematic illustration of an example content that may be customized in the environment shown in FIG. 1.

FIG. 3 is a flowchart of an example method that may be implemented in the environment shown in FIG. 1 to automatically customize content based on user feedback.

FIG. 4 is a more detailed flowchart of the method shown in FIG. 3.

FIG. 5 is a diagram of the example computing systems that may be used in the environment shown in FIG. 1 to implement the methods shown in FIGS. 3 and/or 4.

Although specific features of various embodiments may be shown in some drawings and not in others, this is for convenience only. Any feature of any drawing may be referenced and/or claimed in combination with any feature of any other drawing.

### DETAILED DESCRIPTION

The subject matter described herein relates generally to providing online content to a user, and more specifically, to the user of user feedback associated with a first online content provided to a user to serve a second online content to the user as part of an online content delivery system. The online content may be advertisements and the online content delivery system may be an advertising system or network. The subject matter described herein may enable an advertisement to be selected for delivery to a user based on user feedback associated with an advertisement previously provided to the user, thereby potentially increasing the effectiveness of the later-selected advertisement. Embodiments described herein enable a computer system to (i) provide a first advertisement content including a set of first components; (ii) provide a first feedback mechanism associated with at least one first component of the set of first components, (iii) provide a second feedback mechanism associated with the first advertisement content, (iv) receive a user response to the first and second feedback mechanisms, and (v) provide a second component for use in displaying at a user interface in place of at least one of the first components.

The following detailed description illustrates embodiments of the subject matter described in this application by way of example and not by way of limitation. It is contemplated that the subject matter described herein has general application to processing any electronic communication including, without limitation, advertisements, emails, phrases, strings, messages, queries, hashtags, labels, categorization, titles, and/or keywords in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the subject matter described herein are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) providing a first content, such as an advertisement, including a set of first components; b) providing a first feedback mechanism associated with at least one first component of the set of first components, c) providing a second feedback mechanism associated with the first content, d) activating the first feedback mechanism when an electronic pointer or cursor associated with a user interface is positioned over a particular area of the user interface associated with the at least one first component, e) activating the second feedback mechanism when the electronic pointer associated with the user interface is positioned over a particular area of the user interface associated with the first content, f) receiving a user response to the first and second feedback mechanisms, g) retrieving user information associated with a user, h) providing a second component based on the user response a second component for use in displaying at the user interface in place of at least one of the first components.

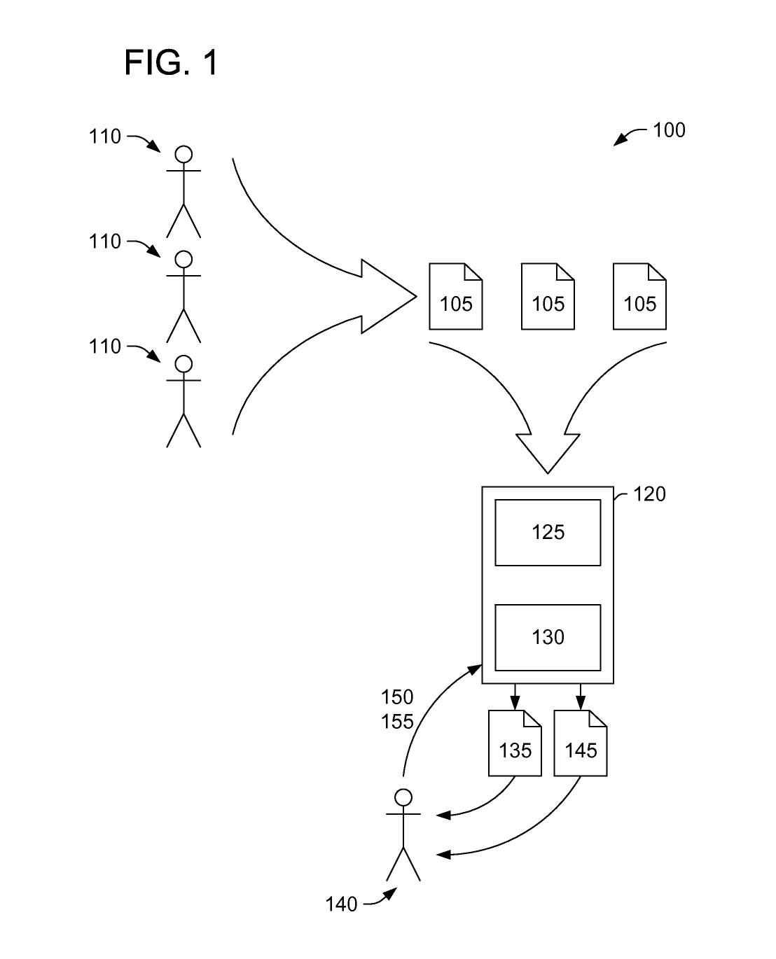

FIG. 1 is a diagram of an example environment 100 for customizing content (e.g., an advertisement) based on user feedback in accordance with one embodiment of the subject matter described herein. In the environment 100, a plurality of advertisements 105 are received from a plurality of advertisers 110. Although only three advertisements 105 and three advertisers 110 are depicted, environment 100 may include any number of advertisements 105 and/or advertisers 110 that enables environment 100 to function as described herein. Even though the environment 100 relates to an Internet advertising scenario, it should be noted that the present disclosure applies to various other environments in which advertisements 105 are customized based on user feedback.

In some implementations, a server system 120 (or other computing device) includes at least a content module 125 and a customization module 130. In some implementations, the content module 125 generates a first content (e.g., a first advertisement) 135 for use in displaying to a user 140, and the customization module 130 generates a second content (e.g., a second advertisement) 145 for use in displaying to the user 140 based at least partially on user feedback (e.g., a user response) 150, 155 provided by the user 140.

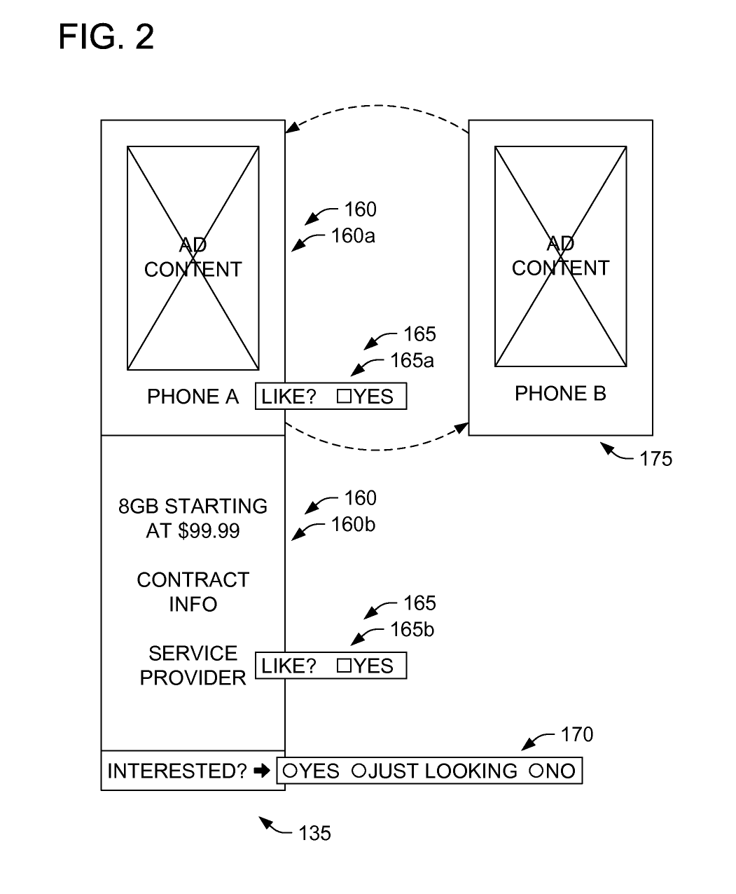

FIG. 2 is a schematic illustration of first advertisement 135. In some implementations, first advertisement 135 includes a set of first components 160, at least one first feedback mechanism 165 associated with a respective component of the set of first components 160, and a survey prompt that includes a second feedback mechanism 170 associated with the first advertisement 135. For example, as shown in FIG. 2, the first advertisement 135 includes an upper first component 160a and a lower first component 160b. Although only two first components 160 are depicted, the advertisement 105 may include any number of first components 160.

In at least some implementations, the first feedback mechanism 165 enables the user 140 to provide a user response 150 associated with a particular portion of the first advertisement 135 (e.g., a first component 160), and the second feedback mechanism 170 enables the user 140 to provide a user response 155 associated with the first advertisement 135, generally. In at least some implementations, the customization module 130 identifies and/or determines a second component 175 based at least partially on user responses 150 and 155 and replaces at least one of the set of first components 160 with the second component 175 to generate the second advertisement 145.

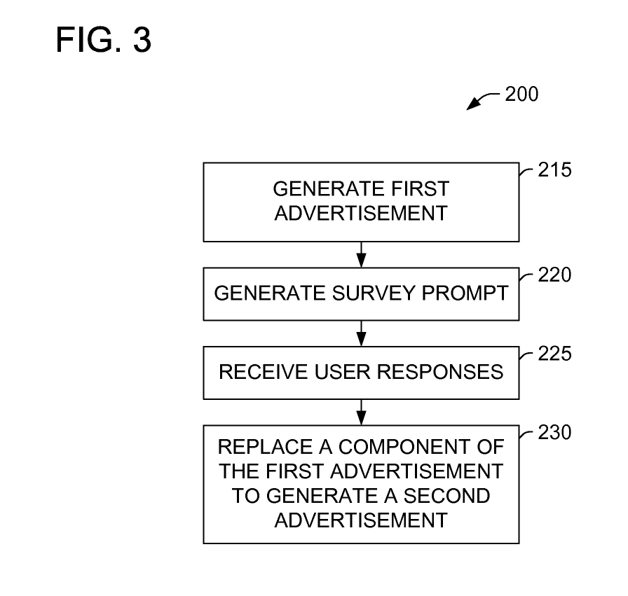

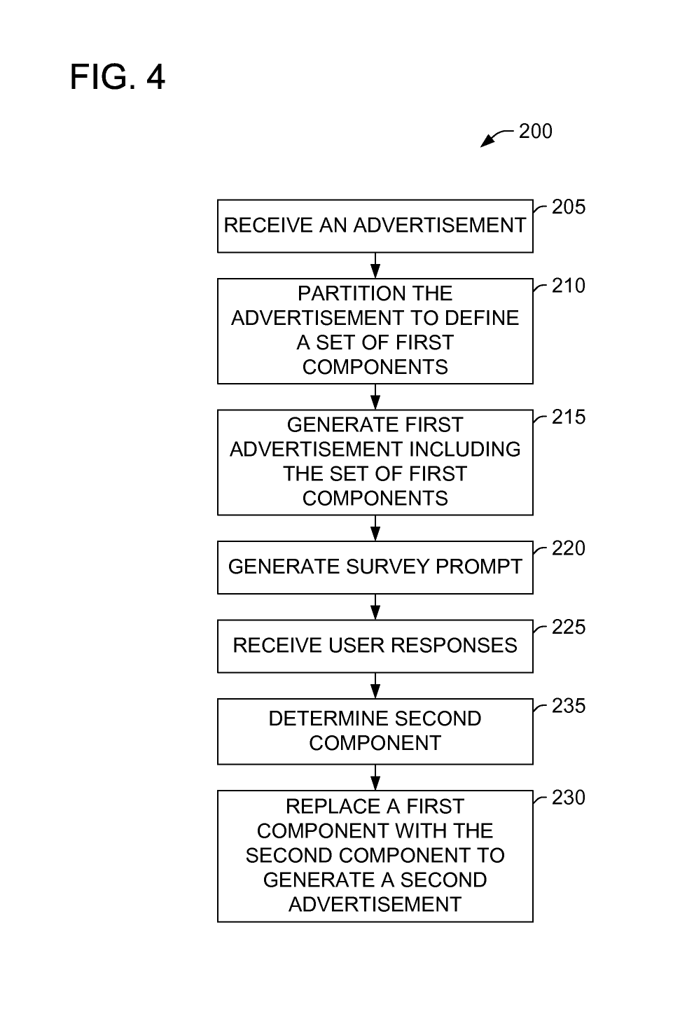

FIG. 3 is a flowchart of an example method 200 that may be implemented to automatically customize the first advertisement 135. FIG. 4 is a more detailed flowchart of method 200. During operation, in some implementations, at least one advertisement 105 is received 205 from an advertiser 110. In one embodiment, the advertisement 105 is partitioned 210 to define a set of first components 160. That is, in such an embodiment, the advertisement 105 is received 205 from the advertiser 110 as a single component, and the advertisement 105 is selectively partitioned 210 to generate the first advertisement 135 including the set of first components 160. For example, as shown in FIG. 2, the upper first component 160a is associated with a product (e.g., a cell phone) and the lower first component 160b is associated with a service (e.g., a service plan for the cell phone). Although only two first components 160 are depicted, the advertisement 105 may be partitioned 210 to include any number of first components 160 that enables method 200 to operate as described herein. Alternatively, the first advertisement 135 may be received from the advertiser 110 including a predetermined set of first components 160.

In some implementations, a first feedback mechanism 165 associated with a first component 160 is generated 215, and a survey prompt including a second feedback mechanism 170 associated with the first advertisement 135 is generated 220. In at least some implementations, the survey prompt is determined and/or generated 220 based on the first advertisement 135. For example, as shown in FIG. 2, the second feedback mechanism 170 solicits a user response 155 that indicates a likelihood of a user 140 purchasing the product (e.g., a cell phone) associated with the first advertisement 135 within a predetermined period of time. Alternatively, the first feedback mechanism 165 and/or the second feedback mechanism 170 may be any feedback mechanism that enables the first advertisement 135 to function as described herein.

In some implementations, the user responses 150 and 155 are received 225 from the feedback mechanisms 165 and 170, respectively. In at least some implementations, the feedback mechanisms 165 and 170 enable a level of interest in, an affinity to and/or a likeability of a particular portion of the first advertisement 135 (e.g., a first component 160) and a purchasing stage (e.g., “not interested,” “just looking,” or “ready to buy”) of the user 140, respectively, to be determined For example, in the example embodiment, the feedback mechanisms 165 and 170 enable the server system 120 to determine a relationship between the user interest in the advertised cell phone and/or the advertised service plan and the user interest in purchasing a new cell phone.

In one implementation of the example embodiment, the server system 120 may determine that the user 140 is interested in purchasing the advertised cell phone but not interested in subscribing to the advertised service plan when the user response 150 to the first feedback mechanism 165a associated with the upper first component 160a and the user response 155 to the second feedback mechanism 170 are both “Yes”. In another implementation of the example embodiment, the server system 120 may determine that the user 140 is interested in subscribing to the advertised service plan but not interested in subscribing to purchasing the advertised cell phone when the user response 150 to the first feedback mechanism 165b associated with the lower first component 160b and the user response 155 to the second feedback mechanism 170 are both “Yes”. In yet another implementation of the example embodiment, the server system 120 may determine that the user 140 is interested in both the advertised cell phone and the advertised service plan when the user responses 150 to all of the first feedback mechanisms 165 are “Yes” and the user response 155 to the second feedback mechanism 170 is “Yes”.

In some implementations, the server system 120 automatically populates and/or determines a user response 150 or 155 based on another user response 150 or 155. For example, in one implementation of the example embodiment, the server system 120 may determine that the user response 155 to the second feedback mechanism 170 is “Yes” when the user responses 150 to all of the first feedback mechanisms 165 are “Yes”. That is, in such an implementation, the server system 120 determines that if the user 170 positively responded to each first component 160 of the first advertisement 135, then, absent a user response 155 to the second feedback mechanism 170 to the contrary, the server system 120 automatically populates and/or determines the user response 155 to be “Yes”. Likewise, in another implementation of the example embodiment, the server system 120 may determine that the user responses 150 to all of the first feedback mechanisms 165 are “Yes” when the user response 155 to the second feedback mechanisms 170 is “Yes”. That is, in such an implementation, the server system 120 determines that if the user 170 positively responded to the first advertisement 135 as a whole, then, absent a user response 150 to any of the first feedback mechanisms 165 to the contrary and/or a user response 150 to one first feedback mechanism 165 that is different from a user response 150 to another first feedback mechanism 165, the server system 120 automatically populates and/or determines all of the user responses 150 to be “Yes”. Alternatively, any user response 150 and 155 may be automatically populated and/or determined to provide any or no feedback based on any factor or criteria that enables the server system 120 to function as described herein.

In at least some implementations, the feedback mechanisms 165 and 170 are configured to activate (e.g., pop up window, drop down menu) when a pointer is positioned over (e.g., mouse pointer is moved over) the first component 160 and the first advertisement 135, respectively. Alternatively, the first feedback mechanism 165 and/or the second feedback mechanism 170 may be continuously displayed with the first advertisement 135.

In some implementations, at least one of the first components 160 is replaced 230 with a second component 175 to generate a second advertisement 145 based at least partially on the user responses 150 and 155 to the feedback mechanisms 165 and 170, respectively. In at least some implementations, the second component 175 is identified and/or determined 235 based at least partially on user information associated with the user 140. The user information may be retrieved from any of a variety of sources and may include, without limitation, at least one of a web history, an email history, a search history, a transaction history, activity history, profile information, a social network, and/or any other information explicitly or implicitly obtained.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined Thus, the user may have control over how information is collected about the user and used by a content server.

In one implementation of the example embodiment, the server system 120 may determine 235 a second component 175 associated with another service plan and/or another service provider and replace 230 the lower first component 160b with the second component 175 in response to a “Yes” response for both the user response 150 to the first feedback mechanism 165a associated with the upper first component 160a and the user response 155 to the second feedback mechanism 170. In another implementation of the example embodiment, the server system 120 may determine 235 a second component associated with another cell phone and replace 230 the upper first component 160a with the second component 175 in response to a “Yes” response for both the user response 150 to the first feedback mechanism 165b associated with the upper first component 160b and the user response 155 to the second feedback mechanism 170. Accordingly, in the example embodiment, the feedback mechanisms 165 and 170 enable a second advertisement 145 that is substantially consistent with the user's likes and/or purchasing stage to be generated.

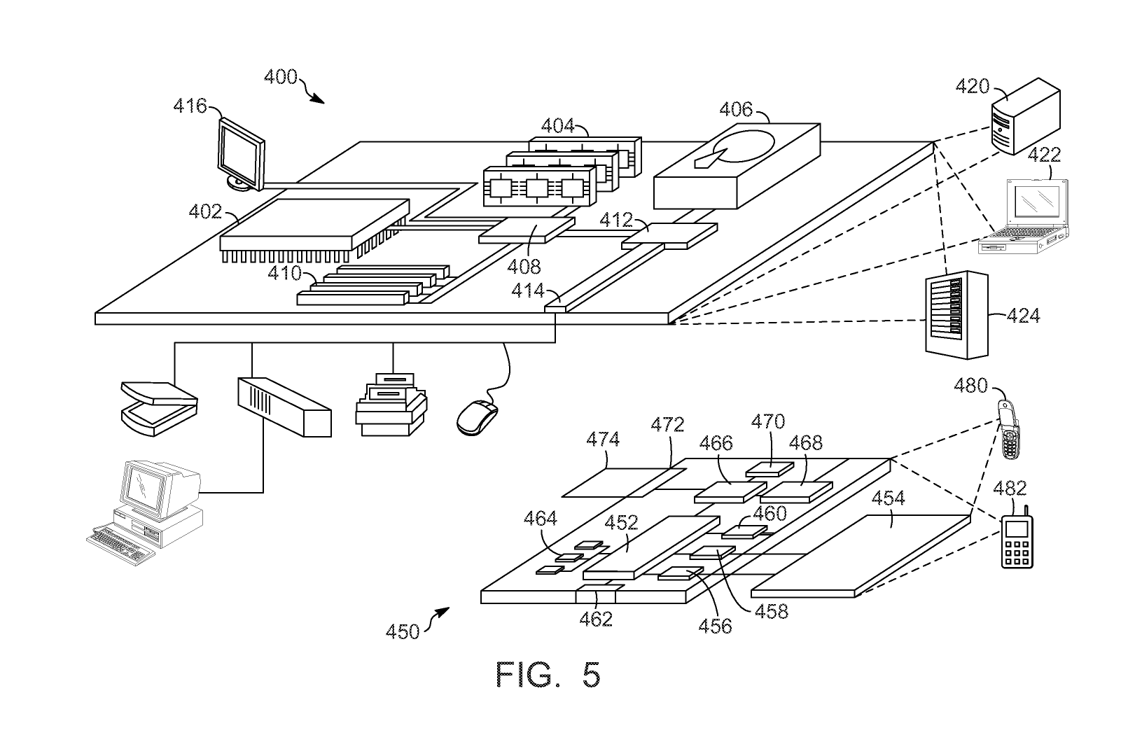

FIG. 5 is a diagram of example computing devices 400 and 450 that may be used in the environment 100. More specifically, FIG. 5 shows an example computing device 400 and an example mobile computing device 450, which may be used with the techniques described here. For example, in some implementations, the user 140 may input user response 150 and/or 155 into computing device 450, which transmits the user response 150, 155 to computing device 400. In such implementations, computing device 400 may store advertisements 105, 135, 145, components 160, 175, and/or feedback mechanisms 165, 170 and be configured to quickly and efficiently match second components 175 to the user 140. For example, computing device 400 may include, for example, at least the content module 125 and the customization module 130.

Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smart phones, and other similar computing devices. The components shown here, their connections and relationships, and their functions, are meant to be example only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of functions is example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with the user 140 through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to the user 140. The control interface 458 may receive commands from the user 140 and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable storage medium, such as the memory 464, expansion memory 474, or memory on processor 452, that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communications may occur, for example, through radio-frequency transceiver 468. In addition, short-range communication may occur, such as using a Bluetooth, WiFi, or other such transceiver (not shown). In addition, GPS (Global Positioning system) receiver module 470 may provide additional navigation- and location-related wireless data to device 450, which may be used as appropriate by applications running on device 450.

Device 450 may also communicate audibly using audio codec 460, which may receive spoken information from the user 140 and convert it to usable digital information. Audio codec 460 may likewise generate audible sound for the user 140, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smart phone 482, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable storage medium” and “computer-readable storage medium” refer to any computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term “machine-readable signal” refers to any signal used to provide machine instructions and/or data to a programmable processor. The machine-readable storage medium does not include a machine-readable signal.

To provide for interaction with the user 140, the systems and techniques described here can be implemented on a computer having a display device (e.g., a CRT (cathode ray tube) or LCD (liquid crystal display) monitor) for displaying information to the user 140 and a keyboard and a pointing device (e.g., a mouse or a trackball) by which the user 140 can provide input to the computer. Other kinds of devices can be used to provide for interaction with the user 140 as well; for example, feedback provided to the user 140 can be any form of sensory feedback (e.g., visual feedback, auditory feedback, or tactile feedback); and input from the user 140 can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which the user 140 can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing systems 400 and 450 are configured to transmit, receive, and/or retrieve advertisements 105, 135, 145, components 160, 175, feedback mechanisms 165, 170, and/or other information from various other computing devices connected to computing devices 400 and 450 through a communication network, and store these advertisements 105, 135, 145, components 160, 175, feedback mechanisms 165, 170, and/or other information within at least one of memory 404, storage device 406, and memory 464. Computing systems 400 and 450 are further configured to manage and organize these advertisements 105, 135, 145, components 160, 175, feedback mechanisms 165, 170, and/or other information within at least one of memory 404, storage device 406, and memory 464 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely examples or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the features may have different names, formats, or protocols. Further, systems described herein may be implemented via a combination of hardware and software, as described, or entirely in hardware elements. Also, the particular division of functionality between the various system components described herein is merely example, and not mandatory; functions performed by a single system component may instead be performed by multiple components, and functions performed by multiple components may instead performed by a single component.

Some portions of the above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

1. A computer-implemented method for customizing content for a user, the method implemented using a computing device coupled to a memory device, the method comprising:
providing, for use in displaying at a user interface, a first content including a set of first components, a first feedback mechanism associated with at least one first component of the set of first components, and a second feedback mechanism associated with the first content, wherein the first content includes an online advertisement;
receiving a user response to the first and second feedback mechanisms;
processing, by the computing device, the user response to the first and second feedback mechanisms; and
providing, based on the user response, a second component for use in displaying at the user interface in place of at least one of the first components.

2. A computer-implemented method in accordance with claim 1, wherein the user response indicates a likelihood of the user purchasing a product or service associated with the first content within a predetermined period of time.

3. A computer-implemented method in accordance with claim 1 further comprising:
retrieving user information including at least one of a web history associated with the user, an email history associated with the user, and a social network identifier associated with the user; and
determining the second component based at least partially on the user information.

4. A computer-implemented method in accordance with claim 1, wherein the first feedback mechanism is capable of being activated when an electronic pointer associated with the user interface is positioned over a particular area of the user interface associated with the at least one first component.

5. A computer-implemented method in accordance with claim 1, wherein the second feedback mechanism is capable of being activated when an electronic pointer associated with the user interface is positioned over a particular area of the user interface associated with the first content.

6. A computer system comprising:
a computing device comprising a processor; and
a memory in communication with the computing device, the memory comprising a content module and a customization module, the processor programmed to:
provide, by the content module, a first content including a set of first components, wherein the first content includes an online advertisement;
provide, by the customization module, a first feedback mechanism associated with a first component and a second feedback mechanism associated with the first content,
receive, by the customization module, a user response to the first and second feedback mechanisms,
process, by the customization module, the user response to the first and second feedback mechanisms, and
provide, by the customization module, a second component based on the user response for use in displaying at a user interface in place of at least one of the first components.

7. A computer system in accordance with claim 6, wherein the customization module, when executed by the processor, causes the processor to retrieve user information associated with a user, and determine the second component based at least partially on the user information, wherein the user information includes at least one of a web history associated with the user, an email history associated with the user, and a social network identifier associated with the user.

8. A computer system in accordance with claim 6, wherein the customization module, when executed by the processor, causes the processor to activate the first feedback mechanism when an electronic pointer associated with the user interface is positioned over a particular area of the user interface associated with the at least one first component.

9. A computer system in accordance with claim 6, wherein the customization module, when executed by the processor, causes the processor to activate the second feedback mechanism when an electronic pointer associated with the user interface is positioned over a particular area of the user interface associated with the first content.

10. One or more computer-readable storage media having computer-executable instructions embodied thereon, wherein, when executed by at least one processor, the computer-executable instructions cause the processor to:
provide a first content including a set of first components, a first feedback mechanism associated with at least one first component of the set of first components, and a second feedback mechanism associated with the first content, wherein the first content includes an online advertisement;
process a user response to the first and second feedback mechanisms; and
provide, based on the user response to the first and second feedback mechanisms, a second component for use in displaying at a user interface in place of at least one of the first components.

11. The computer-readable storage media in accordance with claim 10, wherein the computer-executable instructions further cause the processor to retrieve user information, and determine the second component based at least partially on the user information, wherein the user information includes at least one of a web history, an email history, and a social network.

12. The computer-readable storage media in accordance with claim 10, wherein the computer-executable instructions further cause the processor to activate the first feedback mechanism when an electronic pointer associated with the user interface is positioned over a particular area of the user interface associated with the at least one first component.

13. The computer-readable storage media in accordance with claim 10, wherein the computer-executable instructions further cause the processor to activate the second feedback mechanism when an electronic pointer associated with the user interface is positioned over a particular area of the user interface associated with the first content.

14. A computer system comprising:
a processor; and
a computer-readable storage device having encoded thereon computer readable instructions that are executable by the processor to perform functions comprising:
providing a first content including a set of first components, a first feedback mechanism associated with at least one first component of the set of first components, and a second feedback mechanism associated with the first content, wherein the first content includes an online advertisement;
processing a user response to the first and second feedback mechanisms; and
providing, based on the user response to the first and second feedback mechanisms, a second component for use in displaying at a user interface in place of at least one of the first components.

15. A computer system in accordance with claim 14, wherein the functions performed by the processor further comprise retrieving user information associated with a user, and determining the second component based at least partially on the user information, wherein the user information includes at least one of a web history associated with the user, an email history associated with the user, and a social network identifier associated with the user.

16. A computer system in accordance with claim 14, wherein the functions performed by the processor further comprise activating the first feedback mechanism when an electronic pointer associated with the user interface is positioned over a particular area of the user interface associated with the at least one first component.

17. A computer system in accordance with claim 14, wherein the functions performed by the processor further comprise activating the second feedback mechanism when an electronic pointer associated with the user interface is positioned over a particular area of the user interface associated with the first content.

18. A computer-implemented method in accordance with claim 1, wherein at least one of the first feedback mechanism and the second feedback mechanism are included within a survey prompt.

19. A computer-implemented method in accordance with claim 1 further comprising:
receiving an incomplete user response to at least one of the first and second feedback mechanisms;
determining, at the computing device, that an incomplete user response has been received, wherein the incomplete user response includes a responsive portion and an unresponsive portion to the feedback mechanisms; and
processing, at the computing device, the incomplete user response into a completed response by using the responsive portion to determine a value for the unresponsive portion.

20. A computer-implemented method in accordance with claim 1 further comprising:
providing, for use in displaying at a user interface, the first content including a set of first components, a first feedback mechanism associated with at least one first component of the set of first components, and at least one second feedback mechanism associated with the at least one first component of the set of first components;
receiving a user response to the first and the at least one second feedback mechanism;
processing, by the computing device, the user response to the first and the at least one second feedback mechanisms; and
providing, based on the user response, a second component for use in displaying at the user interface in place of at least one of the set of first components, wherein the second component includes at least one feedback mechanism.
